(19) United States
(12) Patent Application Publication
(10) Pub. No.: US 2025/0155698 A1
(43) Pub. Date: May 15, 2025

(54) METHOD FOR ENSURING THE OPERATION OF A TELESCOPE AND DEVICE FOR CARRYING OUT SAID METHOD

(71) Applicant: Vladimir Eliich PASHKOVSKY, St. Petersburg (RU)

(72) Inventor: Vladimir Eliich PASHKOVSKY, St. Petersburg (RU)

(21) Appl. No.: 18/839,874

(22) PCT Filed: Feb. 15, 2023
(86) PCT No.: PCT/RU2023/050027

§ 371 Date: Aug. 20, 2024

(30) Foreign Application Priority Data
Feb. 23, 2022 (RU) 2022104744

(51) Int. Cl. G02B 23/12

(52) U.S. Cl. CPC G02B 23/12

(57) ABSTRACT

Method for supporting operation of a telescope in presence of bright, fast-moving objects, and a device for carrying out the method. When telescope is in operation, its orientation toward a field of observation is determined; an optical observation device is mounted in vicinity of the telescope, the device having field of observation with radius 1-10 degrees larger than field of observation of the telescope; optical observation device is oriented toward field of observation of the telescope; and bright objects are registered and direction and speed of movement thereof are determined. Objects having a speed and direction of movement indicating they are stars are identified, and this data is used for guiding the telescope and optical observation device. Artificial space objects and flying objects are identified, their parameters are determined and used for protecting the results of telescope observations from optical radiation from bright, fast-moving objects, mitigating those effects.

### TECHNICAL FIELD

The invention relates to the field of optical astronomy and is intended to provide for the operation of telescopes in the presence of bright fast-moving objects in the field of observation.

### CONVENTIONAL ART

Astronomical observations in the optical range are at risk of exposure to bright fast-moving objects. Most often, these are low orbit satellites, which are especially visible in the night sky at the beginning and end of the night. Such objects appear in different parts of the optical range and primarily in the visible and infrared parts. It may also be aircraft equipped with signal lights, meteors, space or aerial objects of unknown origin.

Bright satellites create interference not only for observations from the Earth, but also for observations that are conducted from telescopes placed in Space. Such satellites, passing in front of the space-based telescope, leave traces in the form of long lines of considerable width on its images. This exposure may be particularly significant when a bright satellite passes in front of a space-based telescope at a short distance.

Bright satellite images are not only present on the images of a starry sky, made by ground and space-based telescopes. They are also present in the guiding camera images, which are part of the telescope guiding system. This makes it difficult to keep track of the guide stars and introduces additional distortions in astronomical observations, as it disrupts the accuracy of the guiding system.

Thus, there is a need for a solution that effectively protects both astronomical observations and the telescope guiding process from the effects of bright, fast-moving objects such as satellites and airplanes.

Astronomical systems are known, including a telescope and a guiding system, that is, automatic guidance of the telescope into the observation section as the Earth rotates. An example may be the solution of WO2015100738, publication 9 Jul. 2015, IPC G01C-021/02, which describes an automatic astronomical observation system consisting of an astronomical telescope, a celestial guidance servomotor for controlling an astronomical telescope and a control system.

An automatic method of astronomical observations is also provided. When using the system and the observation method, automatic initial detection, automatic focusing and storage of images are performed, automatic astronomical observation can be implemented, an automatic initial detection process without calibration can be implemented, rapid automatic focusing can be adaptively realized, thereby satisfying the need for observation, storage and exchange of the celestial image.

There are known methods and devices for protecting the operation of a telescope from bright moving objects when observing faint objects.

Long Exposure Image Capture Apparatus, RU2717252, US Pat. No. 19.03.2020, IPC G03B 7/08, allows to take images of the starry sky at long exposures under the influence of short-term optical interference from low-orbit satellites. The method of protection provides for the use of an additional shutter that interrupts the arrival of the image on the matrix during the presence of disturbance in the field of view based on the disturbance detector command.

Patent EP3671280, publication 7 Apr. 2021, IPC B64G-003/00 describes a method for determining the exact position of a moving object at any given time. The system implementing the method includes a telescope, a satellite positioning system, and an electronic processor. The telescope includes focusing optics, a mechanical shutter, and a CCD sensor that performs the function, referred to as Time Delay and Integration. When the moving object passes through the telescope's field of view during the period when the mechanical shutter is open, the shifting of the pixel charge in the lines of the CCD sensor is performed at least once, displacing the trace of light left by the image of the moving object along the column of pixels.

The closest equivalent is US Pat. No. RU2754303, Publication 31.08.2021, IPC G02B 23/00. The patent discloses a method for reducing the effect of interference when imaging faint objects. The coordinates of the field of observation of the faint object representing the part of the matrix of the photodetector on which the projection of the captured low-luminous object is located is determined, and the time of recording the observation results of the captured low-luminous object. Based on the signals about the trajectories of the optical interference sources, the time spent by the projections of the optical interference sources on the observation field of the faint object is determined, and overlap the arrival of the optical signal while the projections are in the field of observation of the faint object.

It should be noted that satellite motion trajectory data may be derived from a space object trajectory database (e.g. NORAD) or various Space Situational Awareness-SSA services, or Aerial Object Tracking Services.

However, the error of these data is high enough and these data typically do not contain accurate data on the brightness of the object. This is due to the fact that the brightness of the moving object may change during its movement: when it exits the shadow of the Earth, either due to rotation around its axis, or as a result of approaching one object with the other, which increases the brightness of the combined object, or due to the inclusion of signal lights on the object, switching on the transmitter of the optical communication channel, or for other reasons.

In this case, the brightness is the main parameter, which determines the level of negative impact of the object on astronomical observations.

Examples of protecting telescope guiding systems from interference caused by bright fast-moving objects are not known.

### SUMMARY OF THE INVENTION

The technical result of the invention is an increase in the operating efficiency of a ground or space-based telescope by reducing the effect of optical radiation on the side of bright, fast-moving objects on the operation of the guiding system and on observations of at least one telescope.

A method for ensuring the operation of a telescope in the presence of bright fast-moving objects is that the direction of the telescope's field of observation is initially determined, an optical observation device is installed at the telescope with a radius of the field of observation by one to ten degrees greater than the radius of the telescope's field of observation and then directing it to the telescope's field of observation. At the output of the optical observation device, bright objects are registered, their speed and direction of movement are determined. From the registered objects, i.e. the speed and direction of movement of which indicate that they belong to the class of stars, and using the data to guide the telescope and the optical observation device. Those objects, the speed and direction of movement of which are indicated, are also identified, that they belong to the class of space and flying objects of artificial origin, their parameters are determined and these parameters are used to protect at least one telescope from the effect on the results of observations of optical radiation from the side of bright fast-moving objects.

Thus, the technical result is achieved by the following.

Only objects related to the class of stars are selected for guiding the telescope and the optical observation device, thereby eliminating the effect of bright fast-moving objects on the process of determining the position of stars, which are used as guide stars in the process of guiding. Therefore, the movement of the telescope and the optical observation device following the movement of the celestial sphere will be more accurate, without possible unnecessary shifts from interference from bright fast-moving objects.

However, parameters of bright fast-moving objects falling in the field of observation of the optical observation device are used, in order to eliminate or reduce their impact on the matrix of the photodetector of the telescope and to reduce the negative impact on the observation results.

In addition, the synchronous movement of the telescope and the optical observation device following the movement of the celestial sphere, performed based on the star motion data obtained by the optical observation device, allows to protect the results of observation of the telescope from the effect of bright fast-moving objects with greater efficiency. In this case, the visible speed and direction of movement of such objects in the telescope field of observation and the field of observation of the optical observation device will be the same. For this reason, the parameters of these objects determined by the optical observation device will have the required accuracy.

Thus, two tasks are solved at once on the basis of a single device.

In a particular case, the optical observation device is mounted on a telescope.

Furthermore, the method is characterized in that the location of the optical observation device is further determined and the location data is transmitted to the telescopes simultaneously with the parameters of the registered space and flying objects of artificial origin.

In addition, the distance from the location of the optical observation device to the telescope location should not exceed 300 to 500 meters.

Exceeding may result in parallax to a significant displacement of the projection of fast-moving space objects distant less than 500 km, in the field of observation of the telescope relative to its projection in the field of observation of the optical observation device. As a result, the parameters of bright fast-moving objects will be determined by an optical observation device with insufficient accuracy.

The apparent brightness of fast-moving objects is determined by the mutual orientation of their reflective surfaces, the observer, and the Sun. For this reason, increasing the distance from the telescope to the optical observation device and the associated change in the angle of observation of objects may result in a change in their apparent brightness. This is another reason why an increase in the distance between the telescope and the optical observation device is more than 500 meters, this leads to a decrease in the efficiency of the method.

In addition, the telescope may be placed in space.

A device for implementing the method comprises: a unit for determining the parameters of bright objects, a guiding unit, and a unit for determining the parameters of bright fast-moving objects. At the same time to the output of the unit for determining the parameters of bright objects connected to the input of the guiding unit and the input of the unit for determining the parameters of bright fast-moving objects. The input of the unit for determining the parameters of bright objects is configured to be connected to the output of the optical observation device with the radius of the field of observation of one to ten degrees greater than the radius of the telescope's field of observation. The output of the guiding unit is configured to be connected to a telescope guiding device. The output of the unit for determining the parameters of bright fast-moving objects is configured to be connected to the input of at least one device, reducing the effect of bright fast-moving objects on the results of observations of at least one telescope.

The described method and device allow to protect from the influence of bright objects both the operation of the guiding system and the astronomical observations performed with ground or space based telescopes.

The technical result mentioned for the method also relates to the device.

In a particular case, the device further comprises a spatial location sensor.

In addition, the device is configured to connect to databases of space and flying objects.

The terms and definitions used in this invention.

Matrix of the photodetector of a telescope is a single photosensitive matrix or an array of photosensitive matrices that capture the optical signal coming from the optical system of the telescope to the photodetector.

Matrix of the photodetector of an optical observation device is a photosensitive matrix that captures the optical signal coming from the optical system of the optical observation device to the photodetector.

Telescope field of observation is a field of the matrix of the photodetector of a telescope on which there is a projection of the observed celestial space at a particular observation time.

Optical device field of observation is a field of the matrix of the photodetector of an optical observation device, on which there is a projection of the celestial space with the radius of the field of observation one to ten degrees greater than the radius of the telescope field of observation, and directed to the telescope field of observation.

Field of observation of the guiding unit-a part of the field of the matrix of the photodetector of an optical observation device, on which there is a projection of the celestial space coinciding with the field or a part of the field of observation of the telescope at a particular time of observation.

Radius of the field of observation is a quantity equal to the radius of the circle that surrounds the field of observation of a telescope or the field of observation of an optical observation device.

### BRIEF DESCRIPTION OF THE ATTACHED FIGURES

The accompanying drawings, which are attached to provide a further understanding of the invention and are incorporated in and constitute a part of this specification, illustrate embodiments of the invention and, together with the description, serve to explain the principles of the invention.

In the drawings:

FIG. 1 is a diagram of the interaction of a telescope and an optical observation device.

FIG. 2 shows the field of observation of the guiding unit without the use of the method

FIG. 3 shows the field of observation of the guiding unit when the method is applied.

FIG. 4 shows the field of observation of the optical observation device with a rectangular matrix.

FIG. 5 shows the field of observation of the optical observation device with a circular matrix.

FIG. 6 shows a block diagram of an embodiment of the method.

FIG. 7 shows a diagram of an embodiment of the method with multiple telescopes.

FIG. 8 shows a diagram of mounting an optical observation device on a telescope.

### DETAILED DESCRIPTION OF EMBODIMENTS OF THE INVENTION

Reference will now be made in detail to the preferred embodiments of the present invention, examples of which are illustrated in the accompanying drawings.

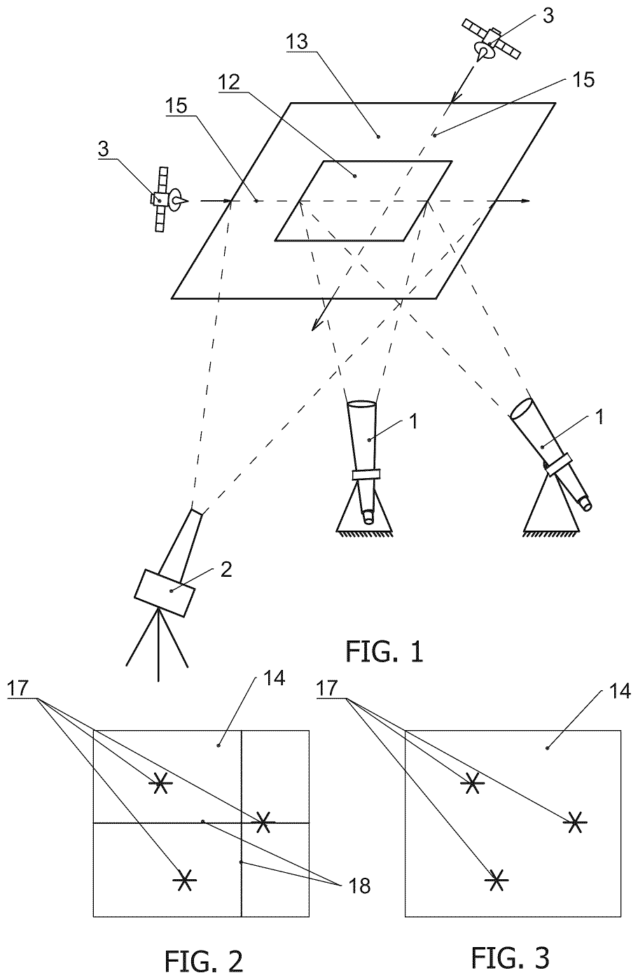

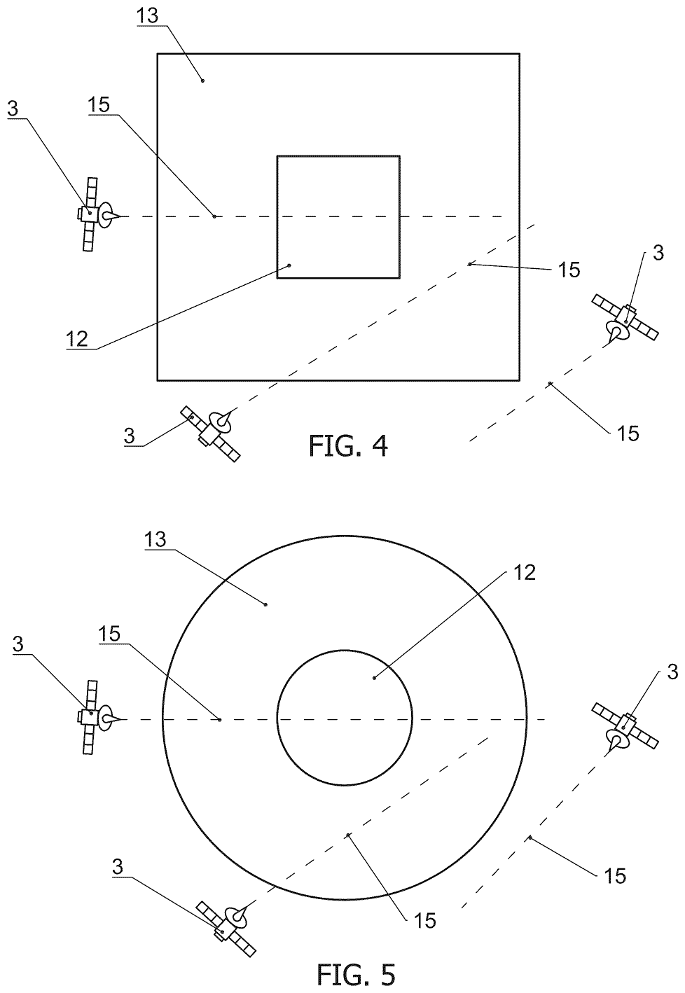

The method for ensuring the operation of the telescope 1 in the presence of bright fast-moving objects 3 (FIG. 1) is carried out using an optical observation device 2. Initially, the direction in the field 12 of observation of the telescope 1 is determined. An optical observation device 2 with a radius of the field 13 of observation one to ten degrees larger than the radius of the field 12 of observation of the telescope 1 is placed near the telescope 1, and is directed toward the field 12 of observation of the telescope 1. FIG. 1, FIG. 4, FIG. 5 show possible trajectories 15 of bright fast-moving objects, such as satellites.

The field 12 of observation of the telescope 1 (FIG. 4) may be rectangular or circular (FIG. 5). Depending thereon, the field 13 of observation of the optical observation device 2 may also be rectangular or circular.

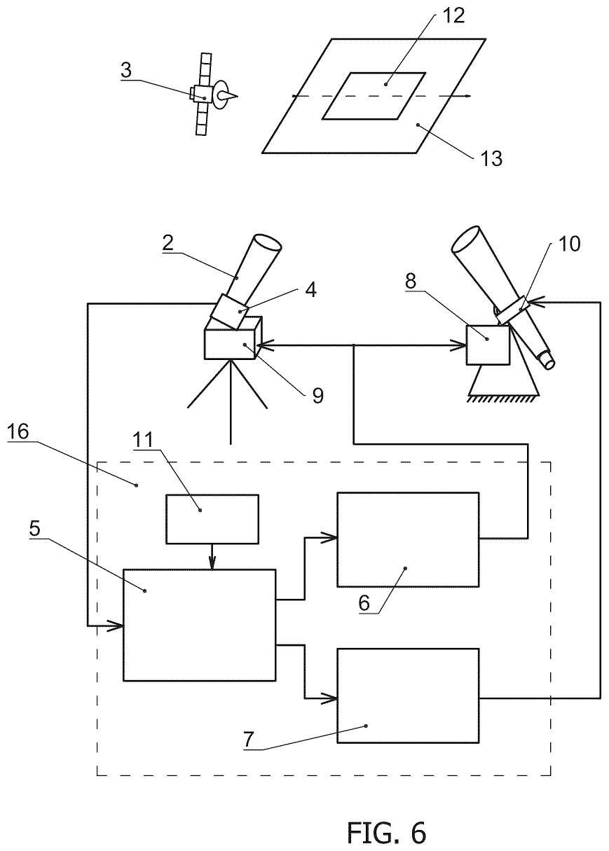

The method allows the operation of at least one telescope 1. This means that the same optical observation device 2 when interacting with the device 16 comprising a unit 5 for determining the parameters of bright objects, a guiding unit 6, and a unit 7 for determining the parameters of bright fast-moving objects (FIG. 6) for implementing the method, can provide operation in the presence of bright fast-moving objects 3 of both one telescope 1 and several telescopes.

In the practice of astronomical observations, situations often arise when several telescopes 1 are simultaneously observed behind the same region of the stellar sky. Such telescopes 1 may be located near each other in one observatory. They may also be in close proximity to each other, as is the case during the meeting of amateur astronomers, which are collected at a single site to observe rare astronomical phenomena. In such a situation, the impact exerted by the bright satellite 3 or aircraft on observation is carried out on a single telescope will be exerted at the same time on observations on neighboring telescopes 1. The method eliminates this impact.

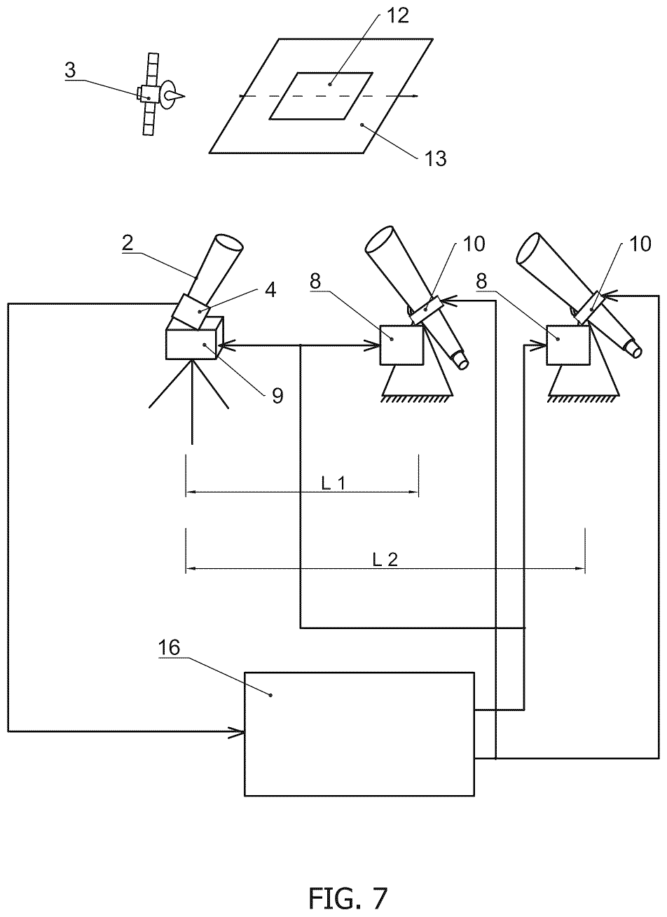

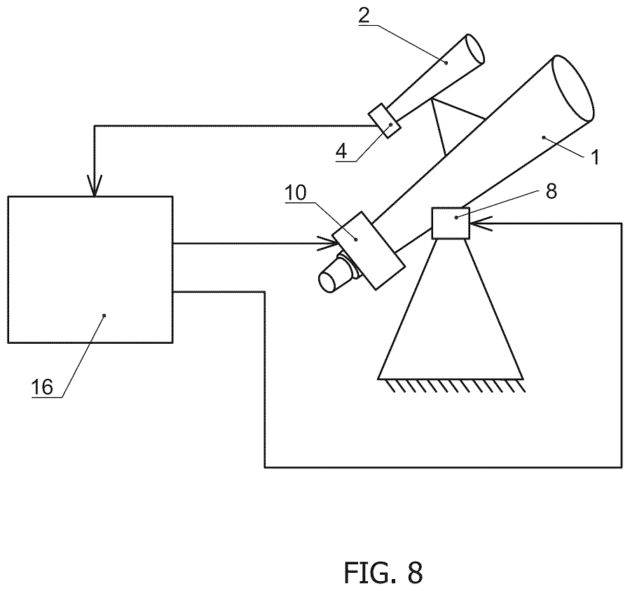

The optical observation device 2 may be mounted directly on the telescope 1 (FIG. 8). In this case parallax, which may occur during the transition from the field 12 of observation of the telescope 1 to the field 13 of observation of the optical observation device 2, essentially no. If the optical observation device 2 and telescopes 1 are spaced from each other (FIG. 1, FIG. 7), the resulting parallax may introduce a significant error in the process of protecting the observation results from bright fast-moving objects.

FIG. 7 shows that distances L1 and L2 from the optical observation device 2 to telescopes 1 should not exceed a distance of 500 m. To monitor the position of the optical observation device 2 when implementing the method, a spatial location sensor 11, such as a GPS sensor (FIG. 6), may be introduced into the device 16 to monitor the distance between the optical observation device 2 and the telescopes 1 connected to the system protecting from bright fast-moving objects.

The optical observation device 2 (FIG. 6) comprises an image formation unit 4 with a radius of field 13 of observation of one to ten degrees greater than the radius of the field 12 of observation of the telescope 1. The output of the image formation unit 4 is connected to a device 16 which implements the method and comprises a unit 5 for determining the parameters of bright objects. In this unit 5, first, those bright objects are identified, the speed and direction of movement of which indicate that they belong to the class of stars, and secondly, those objects are selected, the speed and direction of movement of which indicates whether they belong to the class of space and flying objects.

Connected to the output of the unit 5 for determining the parameters of bright objects are the inputs of the guiding unit 6 and the unit 7 for determining the parameters of bright fast-moving objects.

In the guiding unit 6, signals are generated for the operation of the guiding devices 8 of the telescopes 1 by methods known in the control of the guiding systems. In order to control the guiding in the guiding field 14 (FIG. 3 and FIG. 4) only images of the guide stars 17 are used, as shown in FIG. 3.

If the parameters of bright fast-moving objects were not determined in unit 5 and their traces 18 were not removed from the images that are transmitted to the guiding unit 6, the position of the stars 17 would be determined from the image illustrated in FIG. 2, which would inevitably lead to an incorrect determination of the position of the stars 17 at a given moment and the appearance of errors in the commands of the guiding process.

If the optical observation device 2 is not rigidly mounted on the telescope, it must also be equipped with a guiding device 9, which, like the telescopes guiding devices 8, is controlled by the signals from the guiding unit 6 (FIG. 6, FIG. 7).

In unit 7 for determining the parameters of bright fast-moving objects, their brightness and movement parameters are determined. FIG. 4 and FIG. 5 show the field 12 of observation of the telescope 1 and the field 13 of observation of the optical observation device 2. The centers of these fields coincide. FIG. 4 and FIG. 5 show traces of three bright fast-moving objects 3, in this case of satellites. One trace passes through the field 12 of observation of the telescope 1, the second passes through the field 13 of observation of the optical observation device 2, but does not fall within the field 12 of observation of the telescope 1, the third trace extends away from the field 13 of observation of the optical observation device 2.

The size of the field 13 of observation of the optical observation device 2 surrounding the field 12 of observation of the telescope 1 is selected based on the following parameters:
expected angular velocity of the bright fast-moving objects; at a high speed of such objects, the radius of the field 13 of observation of the optical observation device 2 should be selected larger; this is necessary to take several images of such an object;
frame rate at which the optical observation device 2 works; at a high frame rate, the radius of the field 13 of observation of the optical observation device 2 may be smaller; the high frame rate allows the required number of frames to be obtained in less time, i.e. a smaller distance that the bright fast moving object 3 passes;
number of images needed to determine the parameters of the bright fast moving object 3 (at least two for high brightness objects, at least three for medium and weak brightness objects); if more images need to be obtained, the radius of the field 13 of observation of the optical observation device 2 will be larger; a larger number of images allows for a better shooting of objects with insufficient brightness or variable brightness;
exposure time of these frames, making it possible to obtain images of luminous objects on frames, on the basis of which their speed and direction of movement can be determined with sufficient accuracy; higher exposure frames allow larger object trace images to be obtained and parameters with greater accuracy are determined; while the necessary time of object presence in the field of observation will increase. For this reason, for images with a greater exposure, the radius of the field 13 of observation of the optical observation device 2 should be selected larger;
the duration of the interval between frames, to process frames and recognize images of bright fast-moving objects 3 and stars 17 on them; the larger interval allows processing and recognition with greater accuracy; this also increases the time required for shooting, therefore, the radius of the field 13 of observation of the optical observation device 2 should be selected larger;
the time required to actuate a device 10 of some type mounted on the telescope 1 to reduce the effect of the interference on the results of observations.

The combination of these requirements determines the minimum radius of the field 13 of observation of the optical observation device 2, it must exceed the radius of the field 12 of observation of the telescope 1 by one to ten degrees.

An increase the field 13 of observation is undesirable. As can be seen from FIG. 4 and FIG. 5, it will lead to an increase in the number of objects whose trajectories, although not affecting the field 12 of observation of the telescope 1, but due to the impact in the field 13 of observation of the optical surveillance device 2, the parameters of the luminous objects are processed in the monitoring unit 5. This leads to an increase in the processing time of the parameters of all objects, the occurrence of delays in the processing and an increase in the error when determining the direction and speed of the bright fast-moving objects, passing through the field 12 of observation of the telescope 1.

In order to accurately determine the motion parameters of satellites 3, it is necessary to use a high-resolution optical observation device 2. For this reason, the radius of the field 13 of observation of the optical observation device 2 should not be excessive.

The excessive radius of the field 13 of observation is also unacceptable because it results in geometric distortions of the image.

The output of the unit 7 for determining the parameters of bright fast-moving objects (FIG. 6) is connected to the input of at least one device 10, which reduces the effect of interference data on the results of observations of at least one telescope 1. The devices 10 that reduce the effect of these interference on the results of the observation of the telescopes 1 may be shutters or optical filters, that block the flow of light as bright fast-moving objects pass over the field 12 of observation of the telescope 1. Also, the interference can be reduced by processing the astronomical image at the output of the photodetector matrix after observations or by deactivation of fragments of the matrix of the photodetector of telescope during imaging. Interference may also be reduced by controlling the observation schedule, when the observation start time is determined in such a way that they begin after the bright fast-moving objects exit from the field 12 of observation of the telescope 1, and the observation termination time is determined, to terminate prior to the entry of bright fast-moving objects in the field 12 of observation of the telescope 1.

Transmission of control signals to remote telescope 1 may be performed via wires, radio, IR, optical and fiber optic channel, Wi-Fi or other wireless communications, as well as via the Internet.

To improve the accuracy of predicting the time of appearance of bright fast-moving objects in the field of observation and the accuracy of their identification, parameters known from the databases of space objects and aircraft, for example, the NORAD base, can be used. They are obtained by a receiver connected to these databases over a communication channel. The output of such a receiver may be connected to the device 16, in particular to the input of the unit 7 for determining the parameters of bright fast-moving objects, within which the bright objects will be identified, i.e. correlating the parameters of the objects from the field 13 of observation of the optical observation device 2 with the parameters of the objects from the database. As a result, the accuracy of recognition of such objects is increased.

The units 5, 6 and 7 are elements of the present device and may be combined together in a different configuration. They may also be combined into a single unit 16 or in other words device 16.

The method and apparatus described above may also be used to improve the performance of telescopes deployed in outer space.

The distance between the space-based telescope and the bright fast-moving object, such as a satellite, may be tens of kilometers. The impact of satellites passing in relative proximity to space-based telescopes, compared to their impact on ground-based telescopes, can be more rapid and significant.

In such a situation for timely detection of the passing satellite and determination of its parameters it is necessary to set the maximum possible radius of the field 13 of observation of the optical observation device 2. Exceeding the radius of the field 13 of observation of the optical observation device 2 over the radius of the field 12 of observation of the telescope 1 by more than 10 degrees may result in geometric distortions of the image in the field 13 of observation, which significantly reduces the accuracy of determining the speed and direction of movement of the satellite.

In case the telescope is deployed in outer space, the device 16 can be mounted on the telescope 1. The width of trace that the bright satellite may leave in the field of observation of the optical observation device mounted on the space telescope may be tens or hundreds of pixels. This can lead to the loss of images of many guide stars. In the case of a high risk of the space-based telescope approaching bright satellites, in order to improve the accuracy of guiding, it is necessary to select in advance as guide stars those stars whose images may be subject to illumination from bright satellites with the lowest probability. For this purpose, when star images are processed in the device 16, stars that are not affected by satellites can be selected as guide stars on the basis of known satellite trajectories in advance. The parameters of these trajectories may be obtained, for example, in a format known as Two Line Element set (TLE), or other similar data, through a device for connecting to the databases of the trajectories of space objects. In particular, to NORAD database, databases of various Space Situational Awareness services, other similar databases. Due to the fact that a device can be used to select guide stars that are not affected by bright fast-moving objects, the control of the guiding device 8 of the space-based telescope 1 is carried out with greater accuracy.

Due to the data obtained from the device connecting to the databases of the trajectories of space objects, stars are selected as the guide ones, the images of which are not affected by the trace 18 of the bright satellite.

Similarly, by means of the device for connecting to databases of trajectories of space objects, the efficiency of operation of the device 16 and the method as a whole in a situation can be improved, when astronomical observations are performed by a ground-based telescope.

Radiation from bright objects, which interferes with telescopes and their guiding systems, can occur at various frequencies in the optical range. The greatest impact has radiation in the visible and infrared range. The described method and apparatus can be applied to protect against bright fast-moving interference in any part of the optical range, including visible and infrared.

### INDUSTRIAL APPLICABILITY

The method of ensuring the operation of the telescope and the device for its implementation can be effectively used in existing observation systems in astronomy, both professional and amateur.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. A method for ensuring the operation of a telescope, comprising:
in a presence of bright fast-moving objects, determining the direction on the telescope's field of observation,
installing an optical observation device at the telescope with a radius of the field of observation that is one to ten degrees greater than a radius of a field of observation of the telescope; and
registering the bright fast-moving objects at the output of the optical observation device;
determining speed and direction of movement of the bright fast-moving objects;
identifying registered objects, whose speed and direction of movement indicate that they are stars; and
using data about the registered objects to guide the telescope and the optical observation device, and
selecting those objects, whose speed and direction of movement indicate that they belong to a class of space and flying objects of artificial origin,
determining parameters of the selected objects and using these parameters to protect at least one telescope from the effect on the results of observations of optical radiation from the side of bright fast-moving objects.

2. The method of claim 1, wherein the optical observation device is mounted on the telescope.

3. The method of claim 1, further comprising determining the location of the optical observation device and transmitting the location data to the telescopes simultaneously with the parameters of the registered space and flying objects of artificial origin.

4. The method of claim 1, wherein a distance from the location of the optical observation device to the telescope location does not exceed 300-500 meters.

5. The method of claim 1, wherein the telescope is placed in space.

6. A device for implementing the method, comprising:
a unit for determining parameters of bright objects,
a guiding unit,
a unit for determining parameters of bright fast-moving objects;
wherein an input of the guiding unit and the input of the unit for determining the parameters of bright fast-moving objects are connected to the output of the unit for determining the parameters of bright objects,
and an input of the unit for determining the parameters of bright objects is configured to be connected to the output of the optical observation device with a radius of the field of observation by one to ten degrees greater than the radius of the field of observation of the telescope,
the output of the guiding unit is configured to be connected to the telescope guiding device,
and the output of the unit for determining the parameters of bright fast-moving objects is configured to be connected to the input of at least one device, reducing the effect of bright fast-moving objects on the results of observations of the at least one telescope.

7. The device of claim 6, further comprising a spatial location sensor.

8. The device of claim 6, wherein the device is configured to connect to the databases of trajectories of the space and flying objects.
